(19) United States
(12) Patent Application Publication
(10) Pub. No.: US 2007/0104041 A1
(43) Pub. Date: May 10, 2007

(54) Disc playing sorting system and method using the same

(76) Inventor: Jui-Chiang Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/593,576

(22) Filed: Nov. 7, 2006

(30) Foreign Application Priority Data
Nov. 8, 2005 (TW) 094139197

(51) Int. Cl. G11B 7/085

(52) U.S. Cl. 369/30.27

(57) ABSTRACT

The invention discloses a disc playing sorting system and method. The disc playing sorting system comprises a capacity space, an optical component, and a processor. A plurality of discs are set into the capacity space. The optical component is drived by a trigger signal generated by a start key in order to read the label information of the plurality of discs. A disc playing order list is outputted by a sorting module of the processor based on label information. The disc playing order list is to be a basis for playing the discs in order. Through this disc playing sorting system and the method, user can avoid the complicated processes for setting the plurality of discs into the capacity space in order.

### FIELD OF THE INVENTION

The present invention relates to a disc playing sorting system and a disc playing sorting method and, more particularly, to produce a disc playing order list to be a basis for playing discs.

### BACKGROUND OF THE INVENTION

The development of the digital technology is rapidly developed so that the multimedia information including the audios and images are currently stored as the digital data. The optical storage medium becomes the main storage medium of the digital data due to its easy portability. Therefore, the optical reading equipments are popularized to read the optical storage medium and a disc changer is further developed for containing more discs.

Especially, some films are divided and stored in several discs, and all the discs can be put into the disc changer at the same time for playing discs in turn without changing discs. In order to play the discs in correct disc playing order, the disc changer, generally, has an operation procedure to check the disc order of the discs in the disc changer and plays the discs in order. The conventional operation procedure of the disc changer is described as follows.

Referring to FIG. 1, a flowchart illustrating a conventional operation procedure of a disc changer is shown. The operation procedure comprises the steps of:

Step S11: setting discs into a disc changer by the user;

Step S12: activating a play interface and previewing the discs one by one by trial-and-error method;

Step S13: checking the disc playing order is correct or not. The step S14 is executed if the disc playing order is correct. The step S15 is executed if the disc playing order is incorrect;

Step S14: playing the discs in said order; and

Step S15: ejecting the discs and resetting the discs into the disc changer by the user. The step S12 is executed again until the disc playing order is correct.

According to the conventional operation procedure of the disc changer, the user should place the discs into the disc changer by the correct disc playing order. If not, the discs would be ejected and the user need to place the discs into the disc changer again until the disc playing order is correct. Therefore, the conventional operation procedure of a disc changer is inconvenient and time consuming for the user.

Accordingly, a solution must be provided to overcome the drawbacks and disadvantages by providing a disc playing sorting system and a disc playing sorting method for playing discs in correct order automatically.

### SUMMARY OF THE INVENTION

Briefly, the object of the present invention is to provide a disc playing sorting system and a disc playing sorting method for producing a disc playing order list with a correct disc playing order automatically.

Therefore, the disc playing sorting system of the present invention comprises a capacity space for setting a plurality of discs, an optical component and a processor. The optical component is drived by a trigger signal to read the label information of the plurality of discs. The processor includes a sorting module, and produces a disc playing order list based on the label information.

The present invention also provides a disc playing sorting method. The method comprises: placing a plurality of discs into a capacity space of a disc playing sorting system; starting a start key and providing a trigger signal to drive an optical component of said disc playing sorting system; reading a label information of each of said discs stored in said capacity space; transmitting said label information to a sorting module of a processor; and producing a disc playing order list.

According to the disc playing sorting system and the method, a disc changer is provided to be the disc playing sorting system. A plurality of trays are provided to be the capacity space. A start key is provided to generate the trigger signal. An optical read/write head is provided to be the optical component. A system microprocessor is provided to be the processor and a program is provided to be the sorting module.

Other features and advantages of the present invention and variations thereof will become apparent from the following description, drawings, and claims.

### BRIEF DESCRIPTION OF THE DRAWINGS

FIG. 1 is a flowchart illustrates a conventional operation procedure of disc changer;

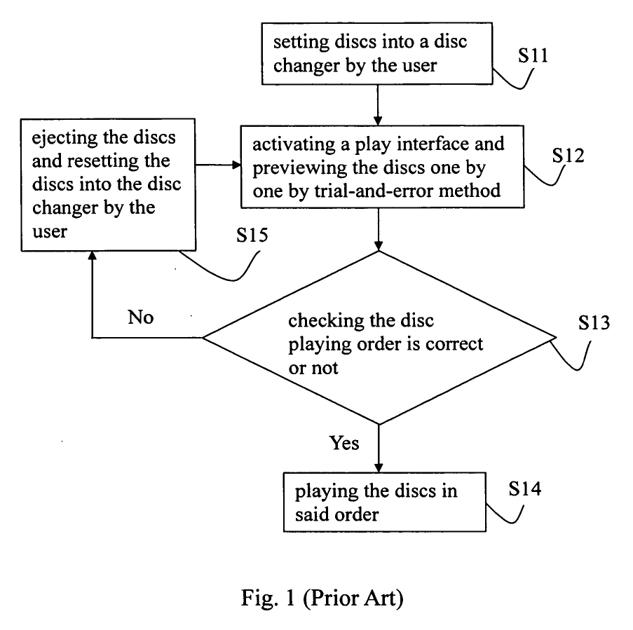

FIG. 2 is a schematic diagram illustrating a disc playing sorting system according to an embodiment of the present invention;

FIG. 3 is a schematic diagram illustrating the processor according to an embodiment of the present invention;

FIG. 4 is a flowchart illustrating a disc playing sorting method according to an embodiment of the present invention;

FIG. 5 is a flowchart illustrating the optical component reading the label information of each disc according to an embodiment of the present invention;

FIG. 6 is a schematic diagram illustrating a disc stored order and a disc playing order list produced through the disc playing sorting method of an example of the present invention.

### DETAILED DESCRIPTION OF THE PREFERRED EMBODIMENTS

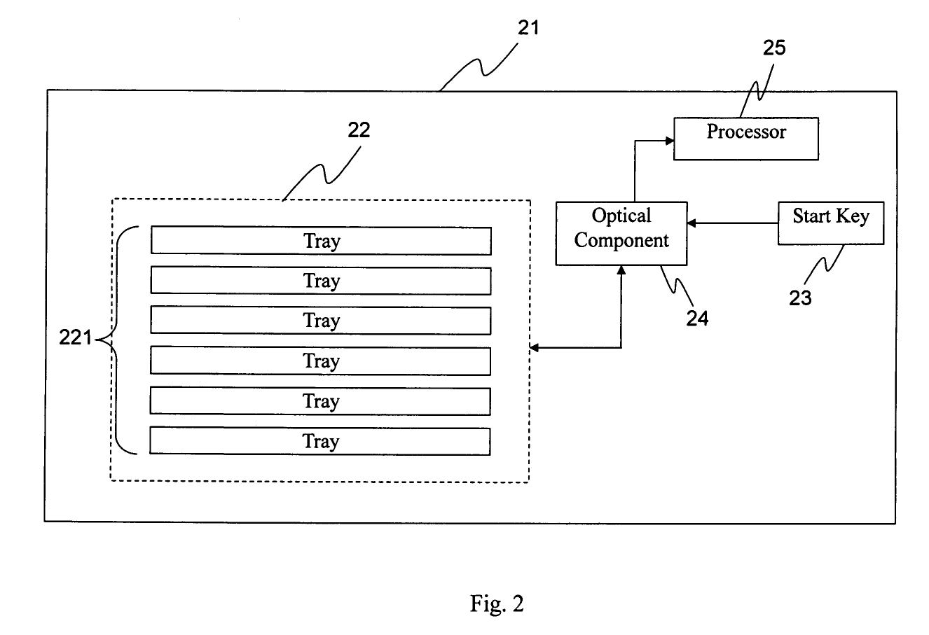

Referring to FIG. 2, a schematic diagram illustrating a disc playing sorting system 21 according to an embodiment of the present invention is shown. The disc playing sorting system 21 comprises a capacity space 22, a start key 23, an optical component 24 and a processor 25. When a plurality of discs are set into the capacity space 22 of the disc playing sorting system 21, a disc stored order showing the sequence of the discs stored in the capacity space 22 may not conform to the correct disc playing order. After the discs are set into to the capacity space 22, a trigger signal is generated when the user starts the start key 23, and then the optical component 24 is drived to read the label information of each disc. The label information of each disc includes a disc playing order and a file type, and all the label information of the discs are transmitted to the processor 25. The processor 25 provides a disc playing order list based on the label information of the discs to play the discs in correct disc playing order. In the preferred embodiment of the present invention, a disc changer is provided to be the disc playing sorting system 21, a plurality of trays 221 are provided to be the capacity space 22, an optical read/write head is provided to be the optical component 24 and a system microprocessor is provided to be the processor 25.

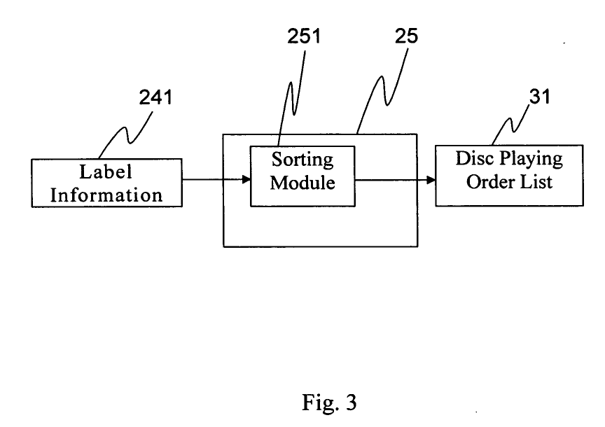

Referring to FIG. 3, a schematic diagram illustrating the processor according to an embodiment of the present invention is shown. A sorting module 251 is set in the processor 25. A disc playing order list 31 is outputted by the sorting module 251 based on a label information 241 of each disc. The outputted disc playing order list 31 can be stored in the processor 25 or other storage media. The sorting module 251 can be a program. The program is executed by the processor 25 to produce the disc playing order list 31.

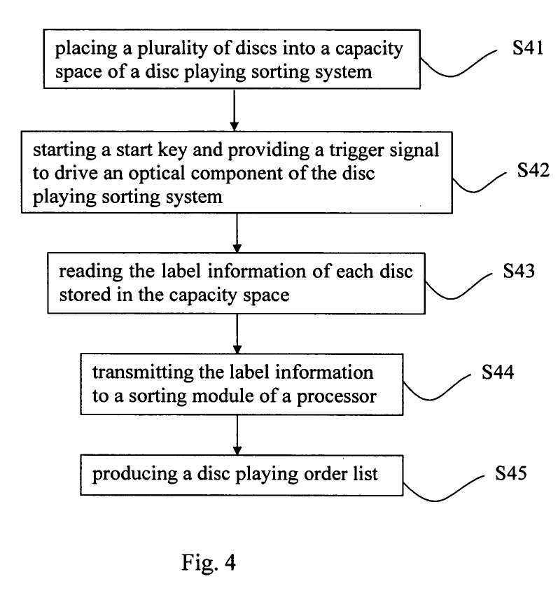

Referring to FIG. 4, a flowchart illustrating a disc playing sorting method according to an embodiment of the present invention is shown. The disc playing sorting method comprises the following steps:

Step S41: placing a plurality of discs into a capacity space of a disc playing sorting system;

Step S42: starting a start key and providing a trigger signal to drive an optical component of the disc playing sorting system;

Step S43: reading the label information of each disc stored in the capacity space;

Step S44: transmitting the label information to a sorting module of a processor; and

Step S45: producing a disc playing order list.

According to the disc playing sorting system and the disc playing sorting method of the present invention, as the user wants to play the discs stored in the capacity space, the disc playing sorting system would produce a disc playing order list according to the disc playing sorting method, and the discs would be played sequentially based on the disc playing order list.

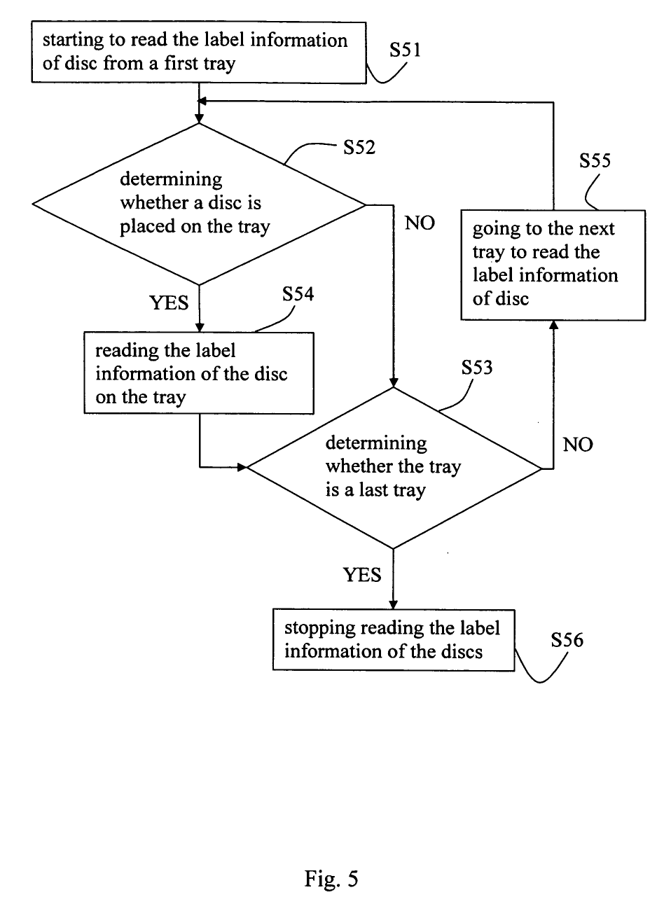

Referring to FIG. 5, a flowchart illustrating the optical component reading the label information of each disc according to an embodiment of the present invention is shown. In the preferred embodiment, the discs are placed on the trays respectively, and the label information of each disc is read by the optical component according to the following steps:

Step S51: starting to read the label information of disc from a first tray;

Step S52: determining whether a disc is placed on the tray. Step S53 is executed if there is no disc placed on the tray. Step S54 is executed if there is a disc placed on the tray;

Step S53: determining whether the tray is a last tray. The step S55 is executed if the tray is not the last tray. Step S56 is executed if the tray is the last tray;

Step S54: reading the label information of the disc on the tray and going to the step S53;

Step S55: going to the next tray to read the label information of disc and the step S52 is executed again; and

Step S56: stopping reading the label information of the discs.

The steps listed above are the detailed steps of the step S43 mentioned above. As the optical component reads the label information of all discs stored in the capacity space by the steps mentioned above, the label information is transmitted to a sorting module of a processor as the step S44 shows.

In next paragraph, an example using the disc playing sorting system and method of present invention to produce a disc playing order list is shown.

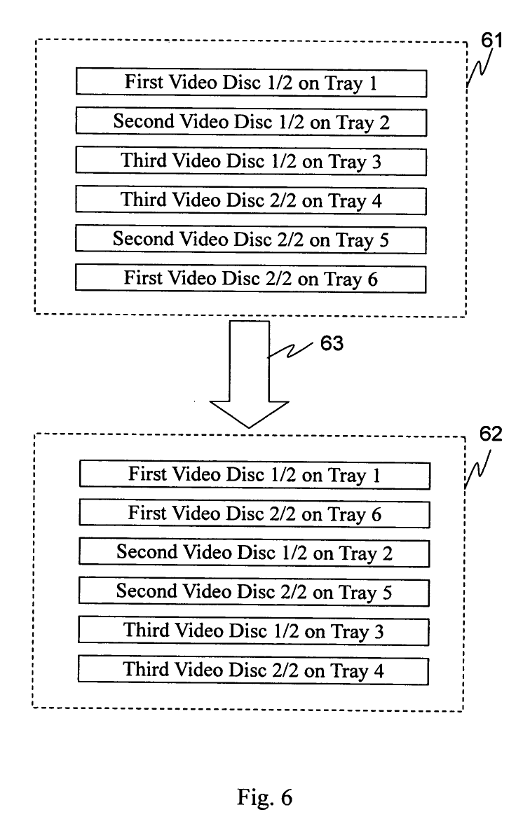

Please refer to FIG. 6, a schematic diagram illustrating a disc stored order 61 and a disc playing order list 62 produced through the disc playing sorting method 63 of an example of the present invention is shown. In the example, a first video disc 1/2, a first video disc 2/2, a second video disc 1/2, a second video disc 2/2, a third video disc 1/2 and a third video disc 2/2 are provided and stored in the capacity space of the disc playing sorting system. A user puts these discs into the capacity space randomly, and therefore a disc stored order 61 is generated. The disc stored order 61 of the discs is random, and it may cause some errors to play the discs following the disc stored order 61. As shown in the disc stored order 61, the second video disc 1/2 is put next to the first video disc 1/2, and it is not correct for the disc playing sorting system to play the second video disc 1/2 after the first video disc 1/2.

According to the disc playing sorting system and method of the present invention, the label information of the discs is read by the optical component and is transmitted to the sorting module in the processor. For example, the label information of the first disc in the disc stored order 61 is “first video disc 1/2 on tray 1” and the second disc in the disc stored order 61 is “second video disc 1/2 on tray 2”. After receiving the label information of all discs, the sorting module resets the disc stored order 61 and produces the disc playing order list 62 which has correct disc playing order. According to the disc playing order list 62, the disc placed on tray 1 is the first disc to be played, and the disc placed on tray 6 is the second disc to be played. Therefore, the discs stored in the capacity space can be played according to the playing order list 62 without mistakes.

According to the disc playing sorting system and method of present invention, a disc playing order list with a correct playing order is automatically produced to be a basis for playing discs. A user does not need to put the discs into the disc changer in order, and it is convenient and timesaving for the user.

Although the features and advantages of the embodiments according to the preferred invention are disclosed, it is not limited to the embodiments described above, but encompasses any and all modifications and changes within the spirit and scope of the following claims.

What is claimed is:

1. A disc playing sorting system comprising:
a capacity space for setting a plurality of discs;
an optical component drived by a trigger signal for reading a label information of said plurality of discs; and
a processor having a sorting module for outputting a disc playing order list based on said label information.

2. The disc playing sorting system of claim 1, wherein said disc playing sorting system is a disc changer.

3. The disc playing sorting system of claim 1, wherein said capacity space is a plurality of trays.

4. The disc playing sorting system of claim 1, wherein said optical component is an optical read/write head.

5. The disc playing sorting system of claim 1, wherein said trigger signal is generated by a start key.

6. The disc playing sorting system of claim 1, wherein said processor is a system microprocessor.

7. The disc playing sorting system of claim 1, wherein said sorting module is a program.

8. The disc playing sorting system of claim 1, wherein said label information includes a file type and a disc order.

9. A disc playing sorting method comprising:
placing a plurality of discs into a capacity space of a disc playing sorting system;
starting a start key and providing a trigger signal to drive an optical component of said disc playing sorting system;
reading a label information of each of said discs stored in said capacity space;
transmitting said label information to a sorting module of a processor; and
producing a disc playing order list.
